(19) United States
(12) Patent Application Publication
(10) Pub. No.: US 2005/0142341 A1
(43) Pub. Date: Jun. 30, 2005

(54) Imaged substrate process and articles

(75) Inventors: Joseph C. Carls, Austin, TX (US); Jonathan P. Kitchin, Leander, TX (US); Dwight L. Evans, Cedar Park, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/062,498

(22) Filed: Feb. 22, 2005

Related U.S. Application Data
(63) Continuation-in-part of application No. 10/277,570, filed on Oct. 22, 2002, now Pat. No. 6,874,421.

(51) Int. Cl. B32B 31/00; B32B 3/00

(52) U.S. Cl. 428/195.1; 156/277; 156/241

(57) ABSTRACT

A method for imparting graphics to a substrate comprises imparting an image to an image carrier sheet comprising an image receptive layer disposed on a carrier sheet. A substrate having a microstructured pressure sensitive adhesive layer disposed on at least a portion of a surface thereof is provided. The image carrier sheet is brought into contact with the adhesive layer of the substrate. Pressure is applied to the image carrier sheet such that one of the carrier sheet and the image receptive layer is adhered to the adhesive layer of the substrate. This method can be utilized for substrates that cannot be easily imaged directly by using, e.g., a conventional ink jet or laser printer.

### CROSS-REFERENCE TO RELATED APPLICATIONS

This application is a continuation in part of U.S. Ser. No. 10/277,570, filed on Oct. 22, 2002, now allowed, which claims priority to U.S. Ser. No. 10/061,874, filed on Jan. 29, 2002, currently pending, which claims priority to U.S. Provisional Application Ser. No. 60/285,216, filed on Apr. 20, 2001, and claims priority to U.S. Provisional Application Ser. No. 60/335,252, filed Oct. 22, 2001. Each of the above-referenced applications are incorporated herein by reference in their entirety.

### FIELD OF THE INVENTION

The invention relates generally to a method and kit for imparting graphics to a substrate. The invention also relates generally to a graphic object.

### BACKGROUND OF THE INVENTION

In recent years a need has arisen for improved flexibility in some printing applications, such as customized printing of signs, promotional materials, advertising media, etc. For example, magnetic signs and retroreflective signs have become popular. However, such signs generally must be printed at a commercial printing facility using specialized equipment, such as laminators, to achieve acceptable visual quality.

Thus, a need exists for a method for imparting customized graphics to various media, including signs, cards, and other media. These and other needs are met by the embodiments of the present invention, as hereinafter described.

### SUMMARY

In one aspect, a method for imparting graphics to a substrate comprises imparting an image to an image carrier sheet comprising an image receptive layer disposed on a carrier sheet. A substrate having a microstructured pressure sensitive adhesive layer disposed on at least a portion of a surface thereof is provided. The image carrier sheet is brought into contact with the adhesive layer of the substrate. Pressure is applied to the image carrier sheet such that one of the carrier sheet and the image receptive layer is adhered to the adhesive layer of the substrate.

In alternative aspects, the substrate can comprise a magnetic sheet, a metal sheet, a metal foil, a plastic sheet, a glass material, a foam material, a reflective sheet, a poster board, a paper or cardboard material, a foil balloon, or combinations thereof.

In some implementations the image receptive layer is permanently bonded to the carrier sheet, and the carrier sheet protects the image.

In alternative implementations, the image carrier sheet can be substantially transparent, translucent, or substantially opaque.

In some implementations, the adhesive layer can comprise an adhesive having a microstructured surface where the microstructured surface of the adhesive is adapted to allow the escape of gases underneath the image receptive layer. The adhesive layer may cover the entire substrate surface, or a portion thereof. The microstructured surface may, for example, have adhesive comprising one or more arrays of grooves spaced at a frequency from 5 to 300 lines per inch. Also, the adhesive layer can be covered with a release liner that is removed prior to bringing the image carrier sheet into contact with the adhesive layer.

In an exemplary implementation, the adhesive layer provides initial repositionability when contacting the image carrier sheet to the adhesive layer.

In another aspect, a kit comprises at least one substrate having an adhesive comprising a microstructured pressure sensitive adhesive layer disposed on a surface thereof, and at least one image carrier sheet comprising an image receptive layer disposed on the carrier sheet. An adhesive sheet or patch can be disposed on a substrate. Alternatively, the adhesive sheet or patch can be provided separately from the substrate. Suitable substrates include, for example, a magnetic sheet, a metal sheet, a metal foil, a plastic sheet, a glass material, a foam material, a reflective sheet, a poster board, a paper or cardboard material, a foil balloon, or combinations thereof. In some embodiments the adhesive sheet or patch is a pressure sensitive adhesive material such as, for example, a microstructured adhesive material. The microstructured adhesive material can be a pressure sensitive adhesive patch or sheet having a microstructured surface, such as one where the microstructured surface comprises at least one array of grooves spaced at a frequency from 5 to 300 lines per inch. In a further implementation, the adhesive sheet or patch can be protected from contact prior to use by a releasable backing sheet on one or both sides thereof.

The invention is further directed to a graphic object, which can be made using the above method or the above kit of the invention. The graphic object can include, for example, a substrate having a pressure sensitive adhesive area disposed on a surface thereof, and a carrier sheet comprising an image on a receptive layer attached to the carrier sheet.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

FIG. 1 is a flowchart illustrating a method of imparting an image to a substrate according to an exemplary embodiment of the present invention.

FIG. 2 is a schematic illustration of an image carrier sheet suitable for use in the methodology of the present invention;

FIG. 3 is a cross-sectional view of a substrate imprinted in accordance with an embodiment of the present invention.

FIG. 4 shows another cross-section view of the components of an exemplary graphics article, prior to final adhesion.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

The present invention provides a method for imparting graphics to various substrates. This method can be utilized for substrates that cannot be easily imaged directly by using, e.g., a conventional ink jet or laser printer. The present invention is also directed to a kit that includes components for imparting graphics to various substrates. The present invention is also directed to a graphic object, which can be made using the above method or the above kit. Using the above aspects of the present invention, graphics with acceptable visual quality can be produced, thereby eliminating the need for utilizing specialized equipment.

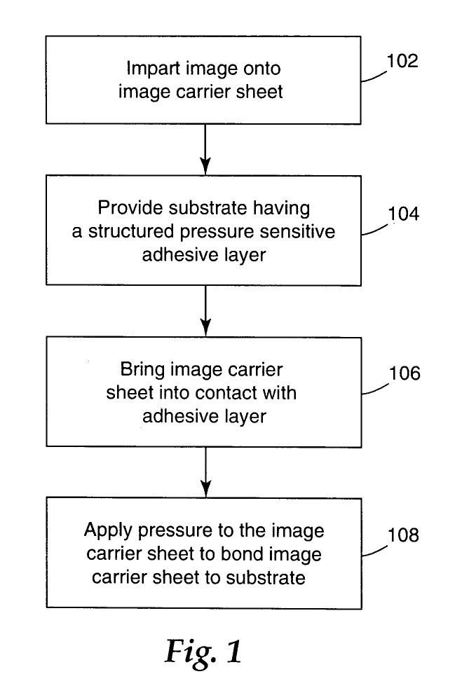

In a first exemplary embodiment, a method for imparting graphics to a substrate is illustrated with respect to the flow chart shown in FIG. 1. Method 100 includes imparting an image to an image carrier sheet (step 102). The image carrier sheet comprises an image receptive layer disposed on a carrier sheet. The term “sheet” as used to describe the image carrier sheer is not meant to be limiting and may include cut sheets (e.g. 8½″×11″ sheets) or sheeting in roll form.

In addition, a substrate having a microstructured pressure sensitive adhesive layer disposed on at least a portion of a surface thereof is provided (step 104). The image carrier sheet (having an image imparted thereon) is then brought into contact with the adhesive layer of the substrate (step 106). Pressure is then applied to the image carrier sheet such that one of the carrier sheet and the image receptive layer is adhered to the adhesive layer of the substrate (step 108). The structure, composition, and/or formulation of the carrier sheet, image receptive layer, substrate, and pressure sensitive adhesive are described in further detail below.

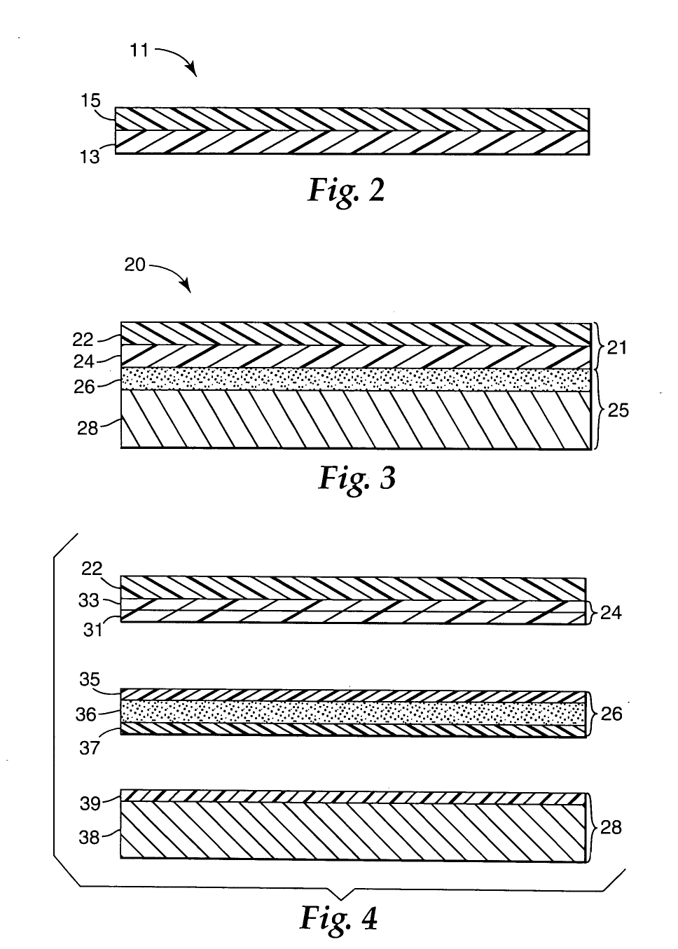

In further detail, in step 102, an image is imparted to an image carrier sheet. For example, as shown in FIG. 2, an exemplary image carrier sheet can be employed. The exemplary image carrier sheet 11 can comprise an image receptor layer 13 coated onto a carrier sheet 15. The image carrier sheet 11 may optionally comprise a second layer (not shown), opposite the image receptor layer 13, that further contributes attributes such as good feedability, specified gloss or resistivity, etc., to the image carrier sheet 11.

The carrier sheet is preferably selected to provide suitable rigidity and other desirable physical characteristics to the overall construction to allow reliable feeding through a conventional laser printer or copier, an ink jet printer or copier, as well as other printers or copiers. In addition, the image carrier sheet 11, or one or more of its components, can be substantially transparent, translucent, or substantially opaque. For example, a conventional transparency film, available from 3M Company, Saint Paul, Minn., can be used as the image carrier sheet 11. The image carrier sheet 11 can be a standard size (e.g., 8½×11″, A4, etc.) or can be any size that can be imaged by a conventional printing device. The image carrier sheet can originate and be imaged in either roll form or sheet form.

The image can be imparted to the image carrier sheet through the use of an inkjet printer, a laser printer, or another conventional printing device. For example, the image carrier sheet 11 can be loaded into the printer, and the image or design is then printed onto the image receptor layer 13. The image or design can be a black and white image or a color image created by a user with a conventional computer program having graphics capability. Alternatively, some or all of the image can be drawn or made by hand.

A substrate is provided in step 104. The substrate may comprise, e.g., a polymer, a metal, a magnetic material, etc. For example, the substrate can be a magnetic sheet, a metal sheet, a plastic sheet, a glass material, a foam material (e.g., a PVC foam material, a polystyrene foam material, etc.), a reflective sheet, a poster board, a paper or cardboard material, a foil balloon, or some combination thereof (e.g., a reflective sheeting adhered to a magnetic substrate). The substrate may be provided as a cut sheet or provided in roll form. The substrate may comprise a material that is substantially transparent, translucent, or opaque, and whose surface gloss may be specified.

In addition, the substrate can include an adhesive layer adhered to at least a portion of a surface of the substrate. In an exemplary embodiment, the adhesive layer comprises a microstructured pressure sensitive adhesive material. For example, the microstructured pressure sensitive adhesive material can comprise a layer of Controltac™, available from 3M Company, Saint Paul, Minn., or a layer of Controltac™ with Comply™, available from 3M Company, Saint Paul, Minn. The adhesive layer may further include a release liner covering the adhesive surface that is to be attached to the image carrier sheet. Further details and alternative pressure sensitive adhesive materials are described below.

In step 106, the image carrier sheet can be brought into contact with the adhesive layer. The image carrier sheet can be placed such that the image receptive layer directly contacts the adhesive layer of the substrate (i.e., image side in). Alternatively, the carrier sheet side of the image carrier sheet is placed in contact with the adhesive layer of the substrate (i.e., image side out). When the image carrier sheet is placed on the substrate image side in, the carrier sheet portion can act to protect the image receptive layer from damage or alteration, such as by excessive contact, scratches, or by the elements.

In an exemplary embodiment, for an adhesive layer having a release liner, the release liner can be removed from the substrate to expose the adhesive layer to the image carrier sheet. Through the use of an exemplary microstructured pressure sensitive adhesive layer, such as a layer of Controltac™ material, the user can place the image carrier sheet onto the adhesive layer at an initial position, observe the appearance of the graphic, and reposition the image carrier sheet to a second position, and if desired, a third position, and so on until satisfied with the position of the graphic.

As a desired position is established, in step 108, pressure can be applied to the image carrier sheet placed on the pressure sensitive adhesive to adhere or bond the image carrier sheet to the substrate. In an exemplary embodiment, pressure can be applied using a tool, such as a squeegee-type hand tool or roller, to smoothly apply pressure and substantially remove all air pockets from the space between the image carrier sheet and the adhesive layer of the substrate. The use of an exemplary microstructured pressure sensitive adhesive material, such as a Controltac™ with Comply™ material, further allows for any air bubbles created between the adhesive layer and the image carrier sheet to bleed out, reducing the likelihood of an unattractive appearance and reducing the level of expertise required to achieve acceptable mounting of the image carrier sheet to the substrate. The application of pressure activates the full adhesive properties of the microstructured adhesive layer, thereby adhering the image carrier sheet to the substrate in a manner such that the image carrier sheet cannot be removed from the substrate without the use of significant force.

In another exemplary embodiment, a kit can be provided to a user to allow for straightforward application of the above method. The kit can include one or more image carrier sheets (of a desired or variable sizes), a substrate of a desired composition (such as a flexible magnetic sheeting or a PVC foam poster-type board) having a pre-applied microstructured pressure sensitive adhesive layer disposed on a surface or surface portion thereof, and a hand tool (e.g., a squeegee-type tool, such as a 3M brand PA-1 applicator, available from 3M Company, St. Paul, Minn., or roller) to provide for the straightforward application of a smooth pressure on an imaged image carrier sheet onto the substrate. Optionally, the adhesive layer can be provided as a separate item. For example, a user can select a desired image and print the image onto a selected image carrier sheet. The user can then place the imaged image carrier sheet onto the adhesive portion of the substrate (e.g., after removal of the release liner, where applicable). After positioning/repositioning to a desired place on the substrate, the user can employ the hand tool to apply pressure to the positioned image carrier sheet to activate the final bonding and to remove all remaining air bubbles. Thus, this embodiment of the present invention can provide acceptable visual quality (e.g., similar quality to that of graphics provided by commercial printing companies) without the need for specialized equipment, allowing the general consumer population to create signs, graphic articles and mounted graphic articles from the home.

FIG. 3 shows an exemplary cross-section structure of an exemplary graphic article 20 formed by the above method. FIG. 4 shows another cross-section view of the components of an exemplary graphic article, prior to final adhesion. Article 20 includes an image carrier sheet 21 and a substrate 25. The image carrier sheet 21 includes a carrier sheet 22 and an image receptor layer 24, which includes an imprinted graphic image (not shown). As shown in FIG. 4, the image receptor layer may include top and bottom portions 33 and 31. The substrate 25 can include a substrate material 28 having a microstructured adhesive material layer 26 disposed thereon. As is shown in FIG. 3, in an exemplary embodiment, the image receptor layer 24 can be in direct contact with the microstructured adhesive layer 26. As shown in FIG. 4, the microstructured adhesive layer (prior to final adhesion) may include a Controltac™-type microstructured adhesive 36 disposed between one or more release liners (e.g. liners 35 and 37). In accordance with the above description, alternative structures can be implemented. For example, microstructured adhesive layer 26 can cover all or part of substrate material 28. In addition, substrate material 28 can include one or more materials. For example, substrate material 28 can comprise a flexible magnetic material 38 having a vinyl or other polymeric material 39 (see FIG. 4) disposed between the magnetic material 38 and the microstructured adhesive layer 26. Other constructions of the substrate will also be apparent to those of skill in the art given the present description.

Further details of the composition, formulations, and/or constructions of the various elements described above are provided below.

Image Carrier Sheets

Image carrier sheets suitable for use in exemplary embodiments of the invention include those with an image receptor layer, which is permanently or releasably attached to a carrier sheet. Suitable image carrier sheet constructions include those described, for example, in PCT Intl. Pub. No. WO 00/02735, which is incorporated by reference herein in its entirety. As mentioned above, image carrier sheets may be provided in cut form or in roll form. The various components of these image carrier sheets are described in greater detail below.

Image Receptor Layer

The image receptor layer used in the image carrier sheets of the exemplary embodiments of the present invention can be a single layer or a laminate of two or more layers. While the descriptions of some of the embodiments of the image receptor layer herein refer to two layers (namely, a bottom surface layer and a top surface layer), it is to be understood that the properties of both layers could be combined into a single layer, or could be further separated into a greater number of layers. In the case of multiple layer image receptive coatings, the layer that is contiguous with the carrier sheet may serve the purpose of a protective outer layer after the image is transferred. Such a construction is described, for example, in U.S. Pat. No. 5,766,398. Alternatively, the surface of the carrier sheet may have suitable properties to allow it to be directly imaged and thereby operate as the image receptor layer without the need for a separate image receptor layer. In this case the carrier sheet possesses sufficient properties of both the carrier sheet and the image receptor layer.

Bottom Surface Layer of Image Receptor

The bottom surface layer of the image receptor layer can be constructed from a variety of compositions, and can be selected such that, in some implementations, it can release from the carrier sheet under normal conditions of use while at the same time adhering to the carrier sheet sufficiently well so that it does not undergo premature delamination during handling. Compositions suitable for use in this layer include those disclosed in U.S. Pat. Nos. 4,379,804; 4,935,307; 5,045,391; 5,108,865; 5,208,092; 5,342,688; 5,389,723; and 5,747,148.

Some specific, non-limiting examples of these materials include poly(vinylpyrrolidone), copolymers of vinylpyrrolidone (e.g., with ethylene or styrene), poly(vinyl alcohol), polyacrylic acids, polymethacrylic acids or (1-alkyl) acrylic acid copolymers and the inorganic salts thereof (such as the alkali metal salts), poly(alkylene oxides) or polyglycols, carbohydrates, alkyl and hydroxyalkyl cellulose derivatives, starch and starch derivatives such as hydroxyalkyl starches, carboxyalkyl celluloses and their salts, gum arabic, xanthan gum, carageenan gum, proteins and polypeptides. The bottom surface layer of the image receptor may also comprise a water-insoluble polymer such as a polyolefin, polyacrylate, polyester, polyamide, or polyurethane.

Top Surface Layer of Image Receptor

The top surface layer of the image receptor can be constructed from a variety of compositions. The top surface layer may include various ink jet receptive coatings as are known in the art, such as the compositions called ink jet receptor layers in U.S. Pat. No. 5,747,148. The top surface layer may also include layers suitable for receiving an image from a laser printer. Suitable image receptor coatings may be of the microporous or swellable polymer type. Microporous image receptor coatings, and in particular ink jet receptive coatings, are described, for example, in U.S. Pat Nos. 5,264,275 and 6,037,050, and typically include one or more composite layers comprising a binder material and inorganic particles such as silica or alumina. The particles are arranged in the binder material such that voids between the particles provide porosity.

Swellable polymer type ink jet receptive coatings may also be used in the image receptor layer of the present invention. Such materials are described, for example, in U.S. Pat. Nos. 5,342,688 and 5,389,723. Swellable polymer type ink jet receptive coatings typically comprise one or more hydrophilic polymers such as gelatin, polyvinyl alcohol, polyvinylpyrrolidone, copolymers of vinyl pyrrolidone (e.g., with ethylene or styrene), poly(vinyl alcohol), polyacrylic acid derivatives, (1-alkyl) acrylic acid copolymers and the inorganic salts such as alkali metal salts derived therefrom, cellulose derivatives, including alkyl and hydroxylalkyl cellulose derivatives, polysaccharides, carbohydrates, starch and starch derivatives such as hydroxyalkyl starches, carboxyalkyl celluloses and their salts, gum arabic, xanthan gum, carageenan gum, proteins and polypeptides, poly(alkylene oxides), polyethylene oxides, polyglycols, and polyalkyloxazolines.

Swellable polymer coatings used in the top surface layer may optionally be cross-linked by a chemical or physical cross-linking agents, and may contain additional additives such as inorganic or organic matting agents, quaternary ammonium salt dye fixing agents (mordants), surfactants, humectants, biocides, fillers, UV absorbers, image dye stabilizers, and other such additives. The dried thickness of the ink absorptive layer is typically within the range of about 3 to about 50 microns, and most preferably is within the range of about 8 to about 25 microns.

As noted above, the top surface layer can include dispersed particles or particulates according to the disclosure of U.S. Pat. No. 5,747,148. Non-limiting examples of such dispersed particles or particulates include corn starch or modified corn starches, silica, alumina, titanium dioxide or other white inorganic oxide or hydroxide materials, cotton or flock particles and other cellulose or modified cellulose particulates, calcium carbonate or calcium silicate and other white inorganic silicates, sulfides and carbonates, clays, and talc. The size of the dispersed particles or particulates are typically in the range of approximately 1 to 40 micrometers in diameter, and preferably in the range of approximately 2 to 20 micrometers in diameter. However, the present invention is not particularly limited to any range of particle sizes, so long as there are sufficient particles having sizes large enough to roughen the upper surface of the top surface layer. Dried top surface layer coating weights are typically within the range of about 2 to about 30 g/m². Preferred coating weights are within the range of about 5 to about 20 g/m² for images prepared by inkjet printing. As noted above, the top surface can alternatively include various laser printer receptive coatings, in which case the preferred coating weight can be in the range of from about 0.01 to about 5 g/m². Examples of coatings for laser printers are described in U.S. Pat. Nos. 6,296,931; 5,624,747; and 5,310,595, each incorporated by reference.

Carrier Sheet

A variety of conventional carrier sheets (or sheeting) can be used in practicing embodiments of the methods of the present invention. The carrier sheet may be a cut sheet or roll of any material that has suitable flexibility and rigidity to pass, unsupported, through the feed mechanism of common ink jet or laser printers. Suitable carrier sheets typically have a thickness within the range of about 50 to about 300 microns, and most preferably have a thickness within the range of about 75 to about 150 microns. Non-limiting examples of suitable carrier sheets include plastic films, such as those comprising polyester, polystyrene, polyethylene, polypropylene, polyimides, polyacrylates and polyolefins. In addition, paper based substrates and composites such as photopaper could be used. In some cases, carrier sheets without sufficient rigidity can be made to pass through the printer by placing an additional removable backing sheet (such as, for example, paper) on the side of the carrier sheet opposite the image receptor. There is no particular limit to the area of carrier sheet. However, for most typical applications, the width of the carrier sheet will be within the range of about 2 cm to about 2 m.

The carrier sheet can be permanently bonded to the image receptor layer and can serve as a protective covering after the image receptor layer is adhered on the target substrate. In such embodiments, the carrier sheet will preferably be sufficiently transparent or translucent so as to give adequate visibility to the printed design or image. In these embodiments, the carrier sheet may also be designed to serve numerous other functions. Thus, for example, the carrier sheet can be made to serve as a layer that protects the pattern or image from abrasion, moisture, UV degradation, and other effects. The carrier sheet may also be fashioned as a polarizer, mirror (either a broadband or color mirror), or diffuser, or may be selected to give the image or pattern a gloss, semi-gloss, or matte finish. Alternatively, the image carrier sheet can comprise an opaque material, especially for image-side out applications, e.g., where the carrier sheet is attached to the adhesive on the face opposite the image receptor layer.

Receiving Substrate

The receiving substrate can be a material having a single layer or multilayer composite construction according to the requirements of use. The receiving substrate may comprise e.g. a polymeric film, a magnetic material, etc., covered (fully or partially) on a major surface with a pressure sensitive adhesive, which may be protected by a release liner. The substrate may be provided in cut form (to a desired dimension) or in roll form.

Non-limiting examples of receiving substrates suitable for use in the practice of embodiments of the present invention include reflective substrates, magnetic substrates (such as magnetic films and signs); retroreflective substrates, cellulosic substrates, including naturally and synthetically-modified cellulosics, polyvinyl chlorides, polypropylene and polyethylene, polystyrene, solid and microvoided polyesters, polyolefins, polycarbonates, polyacrylates, polyacrylate esters, and copolymers thereof, including ionomers (e.g., Surlyn™ brand ionomer from DuPont of Wilmington, Del., USA), metals and metal foils such as aluminum foil and steel and aluminum sheeting, plastic films and sheeting, latex substrates, paper or cardboard substrates, wood and wood composites, and glass. Examples of modified-polyolefins suitable for use in embodiments of the present invention are disclosed in U.S. Pat. No. 5,721,086. Any of these substrates may take a variety of forms, including sheets, rolls, balloons, boxes, poster boards, bags, and other substantially two-dimensional and three-dimensional articles.

Adhesive Layer or Patch on Receiving Substrate

In accordance with embodiments of the present invention, an adhesive layer or patch is provided on the surface of the substrate. Preferably, this layer/patch corresponds in size to the image carrier sheet that is to be adhered to the adhesive layer or patch. In some embodiments, multiple patches may be provided on one or both outer surfaces of the substrate, and these patches may have various shapes and sizes.

In an exemplary embodiment, the adhesive layer comprises a microstructured pressure sensitive adhesive material. For example, the microstructured pressure sensitive adhesive material can comprise a layer of Controltac™, available from 3M Company, Saint Paul, Minn., or a layer of Controltac™ with Comply™, available from 3M Company, Saint Paul, Minn. More generally, the adhesive layer/patch can comprise a suitable pressure sensitive adhesive, which may be defined as a material that adheres using applied finger pressure and which is permanently tacky. Pressure sensitive adhesive formulations are described, for example, in Satas, Ed., “Handbook of Pressure Sensitive Adhesives”, 2^{nd} Ed., Von Nostrand Reinhold 1989, and in U.S. Pat. Nos. 2,973,826; 4,112,213; and 5,670,557. Pressure sensitive adhesives typically comprise an elastomeric polymer such as natural or synthetic rubber, acrylic polymers and copolymers, or styrene butadiene copolymers. The adhesive composition typically contains one or more of the following additives: tackifying additives, cross-linking agents, fillers, antioxidants and stabilizers.

Preferably, a relief structure of indentations or protrusions is provided on the outer surface of the adhesive. Such a structure provides fine channels to facilitate the removal of air or gas pockets which may be formed during the lamination process. The surface structure on the adhesive is most conveniently provided by embossing the releasable backing sheet with the complementary relief pattern.

The surface structure of the adhesive can have various morphologies, but is preferably in the form of a series of grooves. Such grooves may be in the form of parallel lines or a cross-hatched pattern which is disposed on the surface of the adhesive. Spacing of the surface features is typically within the range of about 5 to about 300 features per inch, and preferably within the range of about 10 to about 150 features per inch. Adhesive coatings that exhibit surface structures which facilitate the removal of air or gas pockets are described, for example, in U.S. Pat. Nos. 5,650,215; 6,197,397; 5,897,930; and 5,795,636.

In order to permit convenient packaging and handling of the substrate, a releasable backing sheet is often applied to the adhesive prior to use. If the adhesive is applied using an adhesive transfer tape, the releasable backing sheet that is supplied with the adhesive may simply be left in place until the substrate (such as a magnetic material, sign, or balloon) is used to transfer the printed image. Releasable backing sheets, also known as release liners, are well-known and are available from a number of sources. Examples of suitable releasable backing sheet materials for use in the present invention include silicone coated kraft paper, silicone coated polyethylene paper laminates, and the like. In some cases, improved release from the adhesive layer may be achieved by further treatment of the releasable backing sheet with polymeric release agents such as silicone urea resins, urethanes and long chain acrylates, described, for example, in U.S. Pat. Nos. 3,957,724; 4,567,073; and 5,290,615.

Inks

A variety of inks may be used in practicing various embodiments of the present invention. These include those inks commonly available from printer manufacturers for conventional ink jet and laser printing. Such inks commonly comprise a liquid carrier, dyes or pigments, humectants, organic solvents, biocides, and agents to control rheology and surface tension. The inks may or may not be water-soluble. Suitable inks include high pigment density inks that allow for brighter colors without the need to apply heavy or multiple coats. Suitable inks also include high viscosity inks. In addition, as described above, the image may be created using black and/or color toners from a laser printer.

Image Sources

The images to be imparted to the balloons and other substrates in accordance with the present invention may come from a variety of sources. Thus, for example, the images may be input into a computer through the use of a scanner, by the use of a digital camera, by downloading an image from a remote source (such as from a disk, a network, or the Internet), or by creating a new image on the computer through the use of an appropriate software package. In some cases the image may be created partially or completely by hand.

Prior to printing the selected image onto the image-receiving layer, the image may be manipulated, as by adjusting the brightness, colors, contrast, orientation, size, background, foreground, shape and various other visual attributes of the image prior to printing. A variety of image manipulation computer programs are available that are suitable for these purposes. These include, for example, Adobe PageMaker®, Adobe Photoshop®, Adobe Illustrator® (available from Adobe Systems Inc., San Jose, Calif.), PhotoSmart™ (available from Hewlett Packard Co., Palo Alto, Calif.), and the like.

Sealants

A variety of sealant compositions may be used in accordance with embodiments of the present invention to protect the image that has been imparted to the target substrate. These compositions may protect the image from abrasion, moisture or humidity, UV degradation, or fingerprints, and may also prevent the image from retransferring to other objects. These compositions may also be used advantageously to manipulate the finish of the image, thereby providing an image with a finish that is flat, semi-gloss, gloss, or satin. Such sealants may be especially useful when the image carrier sheet is attached to the adhesive in an image side out orientation.

The choice of sealant compositions will depend, in part, on the inks used, the materials of the image receiving layer, and/or the target substrate. However, examples of such compositions include Krylon®#1312 spray, also referred to as Kamar® Varnish, available from Krylon Products Group, Specialty Division, of the Sherwin-Williams Company of Solon, Ohio.

In addition, edge sealing materials may be useful especially when the image carrier sheet is attached to the adhesive in an image side in orientation.

Printing Devices and Methods

A variety of a printing devices may be used to impart an image to the image receiving layers in accordance with embodiments of the present invention. Appropriate printing methods can include, for example, flexography and silkscreen processes. A preferred method for imparting an image to the image receiving layer of the image carrier sheet is through the use of conventional personal and business printers, such as ink jet printers or laser printers, or such other printers as are capable of printing a black and white, single color, or full-color image. Examples of suitable ink jet printers include, without limitation, Hewlett Packard ink jet printers, Lexmark ink jet printers, and Epson ink jet printers. Examples of laser printers and copiers include those conventional models available from Hewlett Packard, Xerox, Lexmark, and Canon.

The present invention shall now be illustrated by reference to the following non-limiting examples.

### EXAMPLES

### Example 1

A precursor to a retroreflective sign was created by laminating a sheet of a microstructured adhesive to a piece of reflective sheeting. For this example, Controltac™ with Comply™ adhesive (available from 3M Company, St. Paul, Minn.) was used along with 3M Engineering grade reflective sheeting. The smooth side of the Controltac™ with Comply™ adhesive was laminated to the reflective sheeting, leaving the microstructured side of the adhesive outward facing and covered by the microstructured release liner. Separately, the image for the final reflective sign was made by reverse printing the image onto a sheet of 3M brand CG3460 transparency film (available from 3M Company, St. Paul, Minn.) using a Hewlett-Packard Deskjet 990 inkjet printer.

The release liner was subsequently removed from the Controltac™ with Comply™ adhesive, exposing the microstructured adhesive. The initial low tack adhesive feature allowed the imaged sheet to be repositioned until satisfactorily placed into final position. The imaged sheet was then laminated to the exposed adhesive, image side in, against the adhesive. Laminating pressure was achieved between the adhesive and the image by using a plastic “squeegee” device, here a 3M brand Applicator PA-1 (available from 3M Company, St. Paul, Minn.). The image was laminated with good contact with the adhesive and with no observed visual evidence of trapped air bubbles.

Comparative Example 1A

The components of EXAMPLE 1 were prepared as in EXAMPLE 1 except that the sign image was laminated image side out, so that the image was exposed in the final construction.

Both constructions in EXAMPLE 1 and COMPARATIVE EXAMPLE 1A demonstrated excellent color brightness in retroreflection. Both constructions were subsequently submerged in water for 16 hours. Much of the ink washed away in the forward laminated sheet, leaving image densities that are very weak compared to the reverse laminated sample. The reverse laminated sample of EXAMPLE 1 showed some damage at the edges, but far less than that the sample of COMPARATIVE EXAMPLE 1A.

### Example 2

A precursor to a retroreflective sign was made as in EXAMPLE 1. Separately, the image for the final reflective sign was made by reverse printing the image onto a sheet of 3M brand CG3700 color laser transparency film using a Hewlett-Packard Color Laserjet® 4600 printer. The transparency was laminated to the reflective sheeting as described in EXAMPLE 1.

### Comparative Example 2A

The components of COMPARATIVE EXAMPLE 2A were prepared as in EXAMPLE 2 except that the sign image was laminated image side out, so that the image was “image side out” in the final construction. The “image side out” laminated color laser construction was much more dim than the “image side in” laminated construction, believed to be the case because the adhesive fills in the surface irregularities associated with the toner, providing an effectively planar and index (of refraction) matched image surface. This minimizes the scattering of the retroreflected light, maximizing the brightness and color purity of the reflected image.

### Comparative Example 2B

The components of COMPARATIVE EXAMPLE 2A were prepared as in EXAMPLE 2 except that the microstructured adhesive was not used. A conventional transfer adhesive that was smooth on both sides was used in its place. Without the microstructured adhesive, the lamination process was more difficult and less effective, as it was very difficult to reposition the sign image. A number of air bubbles were entrained between the layers and were not eliminated during the hand lamination process. In contrast, the construction from EXAMPLE 2 using the Controltac™ with Comply™ adhesive did not show any readily visible entrained air bubbles.

### Example 3

The components of EXAMPLE 3 were prepared as in EXAMPLE 1 except that instead of using reflective sheeting, a piece of flexible magnetic material (Magnum Magnetics, 20 mil) was used in its place, resulting in a digitally printed magnetic sign suitable for indoor or outdoor use.

### Example 4

The components of EXAMPLE 4 were prepared as in EXAMPLE 1 except that the reflective sheeting was laminated using the adhesive on its non-reflective side to a piece of flexible magnetic material (Magnum Magnetics, 20 mil.). Upon laminating the printed transparency to the reflective face of the reflective sheeting, a digitally printed retroreflective magnetic sign suitable for indoor or outdoor use was obtained.

### Example 5

A precursor to a mounted sign was made by laminating a sheet of Controltac™ with Comply™ adhesive to a sheet of Sintra™ foamed PVC board (available from Alcan Composites.) The smooth side of the Controltac™ with Comply™ adhesive was laminated to the Sintra™, leaving the microstructured side of the adhesive out and covered by the microstructured release liner.

Separately, the image for the final mounted sign was made by reverse printing the image onto a sheet of 3M brand CG3700 transparency film using a Hewlett-Packard Color Laserjet® 4600 laser printer.

The release liner was removed, exposing the microstructured adhesive.

The imaged sheet was placed into position, using the Controltac™ with Comply™ adhesive feature to allow for easy repositioning. The imaged sheet was then laminated to the exposed adhesive, image side in, against the adhesive. Laminating pressure was achieved between the adhesive and the image by using a 3M brand PA-1 applicator. The image was laminated achieving good contact with the adhesive and with no evidence of trapped air bubbles. The resulting mounted sign showed high durability, high gloss and good color saturation.

### Example 6

A precursor to a mounted sign was prepared as in EXAMPLE 5.

Separately, the image for the final mounted sign was made by printing the image onto a sheet of 3M brand Print to Last Paper using a Hewlett-Packard Color Laserjet® 4600 laser printer. The release liner was removed, exposing the microstructured adhesive.

The imaged sheet was placed into position, using the Controltac™ with Comply™ adhesive feature to allow for easy repositioning. The imaged sheet was then laminated to the exposed adhesive, image side out, against the adhesive. Laminating pressure was achieved between the adhesive and the image by using a 3M brand PA-1 applicator. The image was laminated achieving good contact with the adhesive and with no evidence of trapped air bubbles. The resulting mounted sign showed high durability, and a matte finish with good color saturation.

### Example 7

A precursor to a mounted sign was made by laminating a sheet of Controltac™ with Comply™ adhesive to a sheet of Lexan™ brand polycarbonate sheeting (available from General Electric Co.) The smooth side of the Controltac™ with Comply™ adhesive was laminated to the Lexan™, leaving the microstructured side of the adhesive out and covered by the microstructured release liner.

Separately, the image for the final mounted sign was made by printing the image onto a sheet of 3M brand Print to Last Paper using a Hewlett-Packard Color Laserjet™ 4600 laser printer. The release liner was removed, exposing the microstructured adhesive.

The imaged sheet was placed into position using the Controltac™ with Comply™ adhesive feature to allow for easy repositioning. The imaged sheet was then laminated to the exposed adhesive, image side in, against the adhesive. Laminating pressure was achieved between the adhesive and the image by using a 3M brand PA-1 applicator. The image was laminated achieving good contact with the adhesive and with no evidence of trapped air bubbles. The resulting mounted sign showed good color saturation and was readable through the Lexan™ sheeting.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

1. A method for imparting graphics to a substrate, the method comprising the steps of:
(a) imparting an image to an image carrier sheet comprising an image receptive layer disposed on a carrier sheet;
(b) providing a substrate having an adhesive layer comprising a microstructured pressure sensitive adhesive material disposed on at least a portion of the surface thereof;
(c) bringing the image carrier sheet into contact with the adhesive layer of the substrate; and
(d) applying pressure to the image carrier sheet such that the image carrier sheet is adhered to the adhesive layer of the substrate.

2. The method of claim 1, wherein the step of bringing the image carrier sheet into contact with the adhesive layer of the substrate comprises bringing the image receptive layer of image carrier sheet into contact with the adhesive layer of the substrate.

3. The method of claim 1, wherein the step of bringing the image carrier sheet into contact with the adhesive layer of the substrate comprises bringing the carrier sheet of image carrier sheet into contact with the adhesive layer of the substrate.

4. The method of claim 1, wherein the carrier sheet protects the image.

5. The method of claim 1, wherein the image carrier sheet is substantially transparent.

6. The method of claim 1, wherein the image carrier sheet is substantially opaque.

7. The method of claim 1, wherein the substrate comprises a magnetic sheet.

8. The method of claim 1, wherein the adhesive layer is covered with a release liner and wherein the release liner is removed prior to bringing the carrier sheet into contact with the adhesive layer.

9. The method of claim 1, wherein the substrate comprises at least one of a magnetic sheet, a metal sheet, a metal foil, a plastic sheet, a glass material, a foam material, a reflective sheet, a poster board, a wood material, a paper or cardboard material and a foil balloon.

10. The method of claim 1, wherein the step of imparting an image comprises imaging the image carrier sheet with one of an ink jet printer and a laser printer.

11. A kit comprising:
(a) at least one substrate;
(b) an adhesive layer comprising a microstructured pressure sensitive adhesive; and
(c) at least one image carrier sheet comprising an image receptive layer.

12. The kit of claim 11, wherein the adhesive layer is disposed on at least a portion of a surface of the substrate.

13. The kit of claim 11, wherein the adhesive layer comprises at least one release liner.

14. The kit of claim 11, further comprising:
a hand tool configured to apply smooth contact pressure to an image carrier sheet disposed on the adhesive layer.

15. The kit of claim 11, wherein the at least one substrate comprises at least one of a magnetic sheet, a metal sheet, a metal foil, a plastic sheet, a glass material, a foam material, a reflective sheet, a poster board, a wood material, a paper or cardboard material and a foil balloon.

16. A graphic object comprising:
a substrate having an adhesive layer comprising a microstructured pressure sensitive adhesive disposed on a surface thereof; and
an image carrier sheet comprising an image on a receptive layer attached to a carrier sheet;
wherein the image carrier sheet is adhered to the substrate by the adhesive layer.

17. The graphic object of claim 16, wherein the image receptive layer is positioned intermediate to the carrier sheet and the substrate.

18. The graphic object of claim 16, wherein the substrate comprises at least one of a magnetic sheet, a metal sheet, a metal foil, a plastic sheet, a glass material, a foam material, a reflective sheet, a poster board, a wood material, a paper or cardboard material and a foil balloon.

19. The graphic object of claim 16, wherein the image carrier sheet is one of substantially transparent, substantially opaque, and translucent.

20. The graphic object of claim 16, wherein at least one of the image carrier sheet and the substrate is in roll form.
